(19) United States
(12) Patent Application Publication
(10) Pub. No.: US 2007/0278844 A1
(43) Pub. Date: Dec. 6, 2007

(54) WHEEL SECURING SYSTEM FOR DIFFERENT WHEEL BEARING UNITS

(75) Inventors: Joachim GIGLA, Lorzweiler (DE); Andre-Alexander KONTER, Eich (DE); Mathias SCHMIDT, Wiesbaden (DE)

Correspondence Address: INGRASSIA FISHER & LORENZ, P.C., 7150 E. CAMELBACK, STE. 325, SCOTTSDALE, AZ, 85251, US

(73) Assignee: GM GLOBAL TECHNOLOGY OPERATIONS, INC., Detroit, MI (US)

(21) Appl. No.: 11/757,090

(22) Filed: Jun. 1, 2007

(30) Foreign Application Priority Data
Jun. 3, 2006 (DE) 102006026119.4

(51) Int. Cl. B60B 1/00

(52) U.S. Cl. 301/35.623

(57) ABSTRACT

The object of the present invention relates to a wheel securing system for the securing of wheels to a motor vehicle, exhibiting on a constant pitch circle diameter passage apertures with constantly determined passage aperture diameters, comprising: Wheel bearing units with projecting elements, always arranged on the same pitch circle diameter, for penetrating the passage apertures of the wheel disk in an installed state, whereby the projecting elements exhibit different external dimensions depending on the wheel bearing unit, and securing elements with passage apertures, which interact with the parts of the projecting elements which project out of the passage apertures, these surrounding these passage apertures radially, in order to secure the wheel disks on the projecting parts at least against axial and/or radial displacement, whereby the securing elements exhibit means for compensating for the different external dimensions of the projecting elements, in order to guarantee, with a constant external dimension, an interaction with the projecting elements which exhibit different external dimensions.

### CROSS-REFERENCE TO RELATED APPLICATION

This Utility patent application claims priority to German Application No. DE 102006026119.4, filed Jun. 3, 2006, which is hereby incorporated by reference.

### TECHNICAL FIELD

The present invention relates to a wheel securing system for securing wheels to a motor vehicle in accordance with a wheel securing system for the securing of wheels to a motor vehicle, which, on a constant pitch circle diameter exhibits passage apertures with constantly determined passage aperture diameters.

### BACKGROUND

Motor vehicles exhibit replaceably mounted wheels for continued movement. In this context the wheels, as a rule, exhibit a wheel disk by means of which the wheel is connected to the vehicle.

The principle is known of connecting the wheel disk of the wheel to a wheel bearing unit. The wheel bearing unit in this situation exhibits stay bolts, which penetrate the wheel disk through corresponding passage apertures, and the part projecting in each case out of the passage apertures is secured by means of a matching counterpiece, so that the wheel disk is securely fitted to the wheel bearing unit. As a rule, the wheel disks are connected to the wheel bearing unit by means of wheel nuts which are placed onto the stay bolts.

As a function of the torque value which is to be transferred, differently dimensioned wheel bearing units are used for different vehicles. In this situation, if greater torque values are to be transferred or in cases of higher vehicle weights, wheel bearing units of larger dimensions are used, with which the stay bolts are arranged on a greater hole or pitch circle diameter than in the case of a vehicle which has a lower torque value to transfer or is lighter in weight. The stay bolts are of different dimensions, depending on the value of the torque to be transferred or the forces to be transferred; i.e. with higher torque/force values to be transferred, the diameter of the stay bolts is of thicker dimensions.

To accord with the different dimensions of the wheel bearing unit, correspondingly adapted wheels must be provided. The multiple provision of wheels is also designated as proliferation.

Accordingly, a disadvantage of the prior art is that, with altered wheel bearing units for different torque/force values to be transferred, provision must be made for a proliferation; that is to say, a new set of wheels must be provided, which leads to substantial effort and, not least, to high costs.

### SUMMARY

One object of the present invention is therefore to procure a wheel securing system with which, with different torque/weight values for different motor vehicles, a wheel can be used with an unchanged wheel disk with altered wheel bearing units.

The technical teaching makes provision for a wheel securing system for securing wheels to a motor vehicle, which on a constant pitch circle diameter exhibits passage apertures with constantly secured passage aperture dimensions, comprising: wheel bearing units with projecting elements always arranged on the same pitch circle diameter for penetrating the passage apertures of the wheel disk in a fitted state, whereby the projecting elements exhibit different external dimensions depending on the wheel bearing unit, and securing elements with passage apertures, which interact with the parts of the projecting elements projecting out of the passage apertures, these surrounding the passage apertures radially, in order to secure the wheel on the projecting parts at least against axial and/or radial displacement, whereby the securing elements exhibit means to compensate for the different external dimensions of the projecting elements, in order, with a constant external dimension, to guarantee an interaction with the projecting elements exhibiting different external dimensions.

Due to the fact that the projecting elements, which for preference are formed with stay bolts provided with a thread, are always arranged on a constant pitch circle diameter, the same rim can always be used with the same pitch circle diameter. Only the outer dimensions of the projecting elements are capable of being changed depending on the torque value or vehicle weight which is to be transferred, with the result that the projecting elements and the passage apertures are arranged on a common pitch circle diameter. In order to secure the wheel on different projecting elements, different securing elements, interacting with the projecting elements must be provided. The securing elements are tightened on the projecting elements by means of a tool placed at the circumference of the securing element. In order to be able to need only one tool for all projecting elements and all securing elements, the outer contour of the securing elements must be of the same design. For preference, the securing elements are designed as nuts. Accordingly, the spanner widths of the nuts must always remain the same in order not to need an unnecessarily high number of mounting tools. In order to guarantee this, the nut must exhibit corresponding means in order to fit onto the projecting elements with different diameters. Thanks to these means, all nuts can be adapted to fit the different diameters of the projecting elements.

For preference, the means are designed as an internal mounting for the securing element designed to match the outer dimension of the projecting elements, arranged in the passage aperture. By simple arrangement of the internal mounting of the internal mounting inside the passage aperture, the nut can be used for projecting elements of different dimensions in respect of their outer circumference. The internal mounting in this situation exhibits an internal thread which corresponds to the thread of the projecting elements. The internal mounting can exhibit an external thread which corresponds to the thread of the nut or the securing element. If appropriate, the internal mounting is to be secured to the securing element against unwanted movement. To do this, the internal mounting can, for example, be securely bonded, screwed, clamped, or otherwise secured in the passage aperture of the securing element.

For preference, the projecting elements exhibit an external thread and the internal mounting exhibits an internal thread corresponding to the external thread, in order to bring about an interaction between the projecting elements and securing element.

As well as a multi-part design of the securing element and internal mounting, for preference the mounting is designed as one piece with the securing element. In this situation, no further securing elements are required.

For further preference, the securing element is designed as a securing nut with an outer dimension constantly designed for the different projecting elements. The securing nut is a conventional standard component, which is already widely used in the securing of wheels. The securing nut is also easy to use and easy to manufacture.

For further preference, the projecting elements are designed as stay bolts with an external thread, which is selected from the group of threads comprising: M12, M14. Conventional types of threads are M12 and M14, in particular for wheel securing. For this reason it is appropriate for the threads used to be designed as M12 and/or M14, since in this way the least number of changeovers is required.

It is also preferred that a brake disk with passage apertures is arranged between the wheel bearing units and the wheel disk, whereby the passage apertures of the brake disk are penetrated by the projecting elements in the mounted state.

### BRIEF DESCRIPTION OF THE DRAWINGS

The present invention will hereinafter be described in conjunction with the following drawing figures, wherein like numerals denote like elements, and

FIG. 1 shows in diagrammatic form, a perspective representation of a wheel securing arrangement in an exploded view;

FIG. 2 shows in diagrammatic form, a cross-section through a part of the wheel securing arrangement; and

FIG. 3 shows in diagrammatic form, a cross-section through a part of the wheel securing arrangement from FIG. 2, represented in an enlargement.

### DETAILED DESCRIPTION

The following detailed description is merely exemplary in nature and is not intended to limit the application and uses. Furthermore, there is no intention to be bound by any theory presented in the preceding background or the following detailed description.

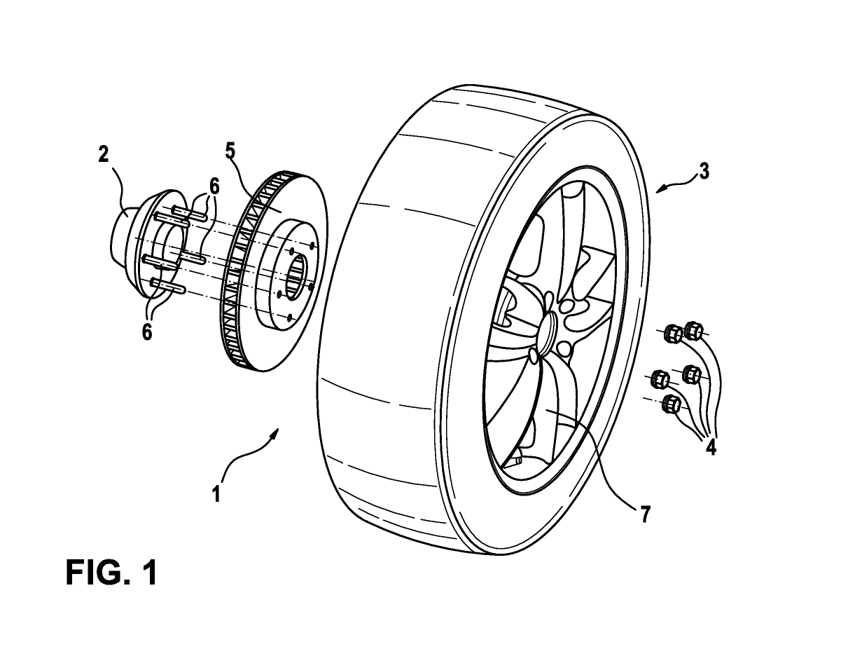

FIG. 1 shows in diagrammatic form a perspective representation of a wheel securing arrangement 1 in an exploded view. The wheel securing arrangement 1 comprises a wheel bearing unit 2, a wheel 3, securing elements 4, and a brake disk 5. The wheel bearing element 2 exhibits projecting elements 6, which are designed as stay bolts. These stay bolts exhibit a thread.

The wheel 3 comprises a wheel disk 7, by means of which the wheel is secured to the vehicle, or more precisely to the wheel bearing unit 2. The wheel disk 7 exhibits passage apertures for this purpose, which in the installed state are penetrated by the projecting elements 6, and which project a certain way out of the passage aperture. In order to secure the wheel 3 to the wheel bearing element 2, securing elements 4 are provided. These securing elements 4 are designed as nuts which exhibit an internal thread. The nuts are designed to fit the projecting elements with the greatest diameter and interact with these.

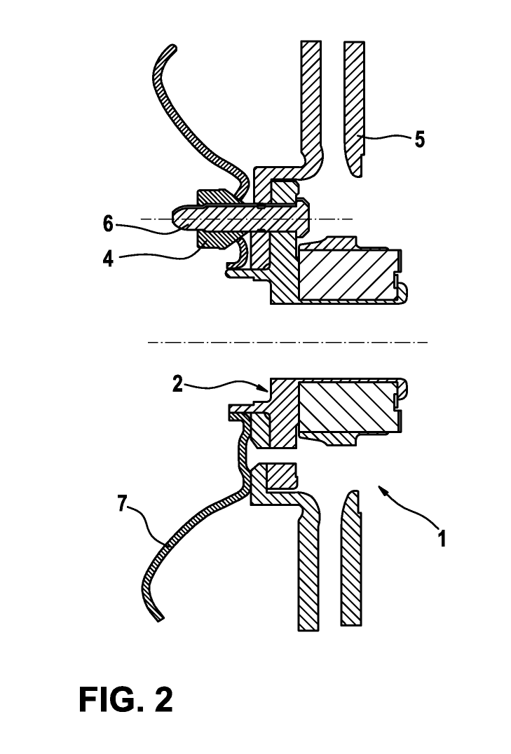

Provided between the wheel bearing unit 2 and the wheel 4 is a brake disk 5, which likewise exhibits passage apertures. The brake disk 5 in the installed state is arranged between the wheel 4 and wheel bearing unit 2. Represented in FIG. 2 is a cross-sectional view of a part of the wheel securing arrangement in the assembled state.

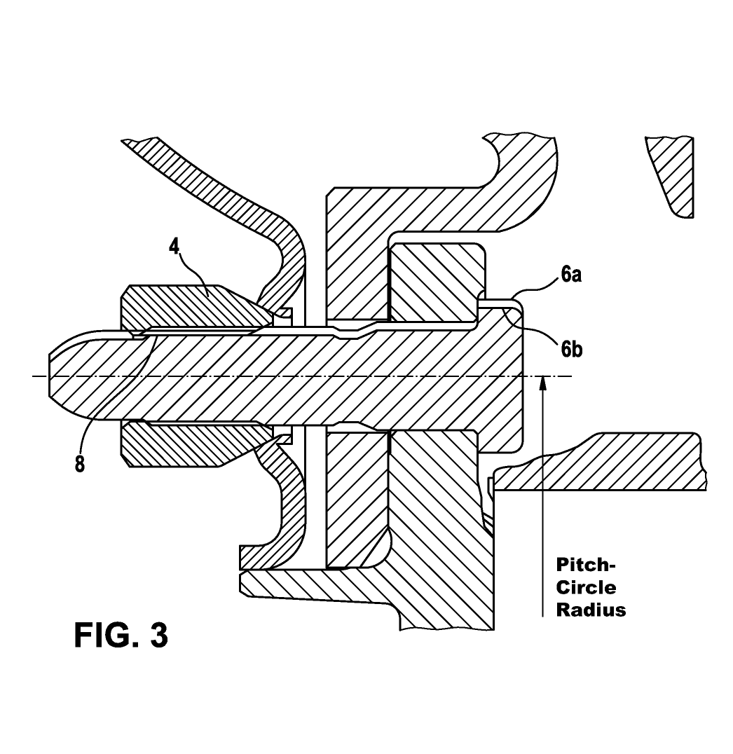

FIG. 2 shows in diagrammatic form a cross-section through a part of the wheel securing arrangement 1. The wheel securing arrangement 1 comprises, as already shown in FIG. 1, the wheel bearing unit 2, the securing elements 4, the wheel (not shown), and the brake disk 5. The wheel is secured by means of the wheel disk 7 to the wheel bearing unit 2. More precisely, the wheel disk 7 is connected by means of its passage apertures to the projecting elements 6 of the wheel bearing unit 2. The wheel disk 7 is secured on the projecting elements 6 by means of a securing element 4 designed as a nut. Represented in an enlargement in FIG. 3 is a section around a projecting element, shown in cross-section.

FIG. 3 shows in diagrammatic form a cross-section through a part of the wheel securing arrangement from FIG. 2, as an enlargement. For contrast, a wheel securing arrangement is represented once with a first projecting element 6a, designed as a stay bolt, and once with a second projecting element 6b. The first projecting element 6a exhibits a greater diameter and is designed in the present case as an M14 stay bolt. The second projecting element 6b exhibits a smaller diameter and in the present case is designed as an M12 stay bolt. Corresponding to this, a securing element 4 is provided which is designed as a nut. In order to be able to be used also as a securing element 4 for the M12 stay bolt, with the same external geometry, the nut exhibits an internal mounting 8. The internal mounting exhibits an M12 internal thread corresponding to the M12 stay bolt. Also indicated in the pitch circle radius on which both the M12 stay bolt as well as the M14 stay bolt is formed.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. Wheel securing system for the securing of wheels to a motor vehicle, which, on a constant pitch circle diameter exhibits passage apertures with constantly determined passage aperture diameters, comprising:
wheel bearing units with projecting elements, always arranged on the same pitch circle diameter, for penetrating the passage apertures of the wheel disk in a mounted state, whereby the projecting elements exhibit different external dimensions depending on the wheel bearing unit; and
securing elements with passage apertures, which interact with the parts of the projecting elements projecting out of the passage apertures, these elements surrounding the passage apertures radially, in order to secure a rim on the projecting parts at least against axial and/or radial displacement, whereby the securing elements exhibit means for compensating for the different external dimensions of the projecting elements, in order to guarantee, with a constant external dimension, an interaction with the projecting elements exhibiting different external dimensions.

2. Wheel securing system according to claim 1, wherein the means are designed as an interior mounting for the securing element, designed to match the external diameter of the projecting elements, the securing element being arranged in the passage aperture.

3. Wheel securing system according to claim 1, wherein the projecting elements exhibit an external thread and the internal mounting exhibits an internal thread corresponding to the external thread, in order to cause an interaction between the projecting elements and the securing elements.

4. Wheel securing system according to claim 2, wherein the internal mounting is designed as a single piece with the securing element.

5. Wheel securing system according to claim 1, wherein the securing element is designed as a securing nut with an external dimension designed as constant for the various different projecting elements.

6. Wheel securing system according to claim 1, wherein the projecting elements are designed as stay bolts with an external thread, which is selected from the group of threads comprising: M12, M14.

7. Wheel securing system according to claim 1, wherein a brake disk with passage apertures is arranged between the wheel bearing units and the wheel disks, whereby the passage apertures of the brake disk in the installed state are penetrated by the projecting elements.
